(19) United States
(12) Patent Application Publication
(10) Pub. No.: US 2024/0352170 A1
(43) Pub. Date: Oct. 24, 2024

(54) RIGID GAS PERMEABLE PREPOLYMER AND RIGID GAS PERMEABLE CONTACT LENS FORMED THEREFROM

(71) Applicant: Bausch + Lomb Ireland Limited, Dublin (IE)

(72) Inventors: Mohammad Vatankhah Varnosfaderani, Rochester, NY (US); Feng-Yang Shih, Rochester, NY (US); Mark R. Mis, Rush, NY (US); Alok Kumar Awasthi, Pittsford, NY (US); Emily Abrams Gabriel, Pittsford, NY (US); Kenneth M. Harty, Salem, NH (US); Peter J. Tinios, Epping, NH (US); Marianne Yarmey, Rockport, MA (US)

(21) Appl. No.: 18/616,615

(22) Filed: Mar. 26, 2024

Related U.S. Application Data
(60) Provisional application No. 63/460,972, filed on Apr. 21, 2023.

(51) Int. Cl. C08F 230/08; B29D 11/00; B29K 33/00; B29K 105/00; G02C 7/04

(52) U.S. Cl. CPC C08F 230/08; G02C 7/04; B29D 11/00038; B29K 2033/08; B29K 2105/0002

(57) ABSTRACT

A rigid gas permeable prepolymer comprising a reaction product of (a) a rigid gas permeable-forming prepolymer comprising (i) monomeric units derived from a bulky siloxane monomer containing an ethylenically unsaturated reactive end group, and (ii) monomeric units derived from a hydrophilic monomer having one or more reactive functionalities and an ethylenically unsaturated reactive end group, and (b) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer. Rigid gas permeable contact lenses formed from the rigid gas permeable prepolymers are also disclosed.

### PRIORITY CLAIM

The present application claims priority to U.S. Provisional Patent Application Ser. No. 63/460,972, entitled “Rigid Gas Permeable Prepolymer and Rigid Gas Permeable Contact Lens Formed Therefrom,” filed Apr. 21, 2023, the content of which is incorporated by reference herein in its entirety.

### BACKGROUND

Contact lenses may be classified in two general categories, soft and hard lenses. Soft contact lenses such as soft hydrogel contact lenses are made of a material with a relatively low modulus, such that the lenses are flexible and bendable. Hard contact lenses have a much higher modulus and are relatively stiff. One class of hard contact lens materials is rigid gas permeable materials. Rigid gas permeable materials are composed of a silicon-containing copolymer and are able to transmit gases, particularly oxygen. Thus, oxygen can be transmitted through a rigid gas permeable contact lens and to the cornea while the lens is worn.

### SUMMARY

In accordance with an illustrative embodiment, a rigid gas permeable prepolymer comprises a reaction product of (a) a rigid gas permeable-forming prepolymer comprising (i) monomeric units derived from a bulky siloxane monomer containing an ethylenically unsaturated reactive end group, and (ii) monomeric units derived from a hydrophilic monomer having one or more reactive functionalities and an ethylenically unsaturated reactive end group, and (b) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer.

In accordance with another illustrative embodiment, a rigid gas permeable contact lens which is a polymerization product of a monomeric mixture comprising:
(a) a rigid gas permeable prepolymer comprising a reaction product of (i) a rigid gas permeable-forming prepolymer comprising (1) monomeric units derived from a bulky siloxane monomer containing an ethylenically unsaturated reactive end group, and (2) monomeric units derived from a hydrophilic monomer having one or more reactive functionalities and an ethylenically unsaturated reactive end group, and (ii) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer, and
(b) one or more rigid gas permeable contact lens-forming comonomers having an ethylenically unsaturated reactive group.

In accordance with yet another illustrative embodiment, a method for making a rigid gas permeable contact lens comprises:
(a) curing a monomeric mixture in a mold, the monomeric mixture comprising:
   (i) a rigid gas permeable prepolymer comprising a reaction product of (1) a rigid gas permeable-forming prepolymer (al) monomeric units derived from a bulky siloxane monomer containing an ethylenically unsaturated reactive end group, and (b1) monomeric units derived from a hydrophilic monomer having one or more reactive functionalities and an ethylenically unsaturated reactive end group, and (2) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer, and
   (ii) one or more rigid gas permeable contact lens-forming comonomers having an ethylenically unsaturated reactive group, and
(b) releasing the rigid gas permeable contact lens from the mold.

### BRIEF DESCRIPTION OF THE DRAWINGS

In combination with the accompanying drawing and with reference to the following detailed description, the features, advantages, and other aspects of the implementations of the present disclosure will become more apparent, and several implementations of the present disclosure are illustrated herein by way of example but not limitation. In the accompanying drawings:

FIG. 1 illustrates the polymer percolation and phase separation for the rigid gas permeable lens of Comparative Example A.

FIGS. 2A and 2B illustrates the polymer percolation and phase separation for the rigid gas permeable lens of Example 4.

### DETAILED DESCRIPTION

Various illustrative embodiments described herein include rigid gas permeable prepolymers and rigid gas permeable contact lenses made therefrom. As mentioned above, contact lenses may be classified in two general categories, soft and hard lenses. For hard lenses (also referred to as rigid gas permeable lenses) there are two particularly desirable properties, namely, hardness and oxygen permeability. The hardness of rigid gas permeable contact lenses is necessary so that the lens is machinable. Most rigid gas permeable contact lenses produced today are manufactured by cutting the lens on a lathe. As an example, the rigid gas permeable prepolymer is cast in the form of a rod, the rod is cut into cylindrical disks (also referred to as buttons), and lenses are lathed from these buttons. Thus, a rigid gas permeable material must have sufficient hardness, and not be brittle, so that it is machinable.

Oxygen permeability is also a desirable property for contact lens materials since the human cornea will be damaged if it is deprived of oxygen for an extended period. Oxygen permeability is conventionally expressed in units of Barrer, and also called Dk. Oxygen transmissibility is a property of contact lens materials related to oxygen permeability where oxygen permeability is divided by lens thickness, or Dk/t.

A challenge in developing improved rigid gas permeable prepolymers is that modifying a copolymer to increase oxygen permeability frequently compromises other desired properties of the material, such as machinability or optical clarity. Present formulations and manufacturing processes for making rigid gas permeable contact lenses with a high Dk of greater than 100 and hardness Shore D greater than 70 are based on per- and polyfluoroalkyl substances (PFAS) materials. Representative examples of such PFAS materials include, but are not limited to, 2,2,2-trifluoroethyl methacrylate and 1,1,1,3,3,3-hexafluoroisopropyl methacrylate. The use of fluorinated materials is undesirable because (1) PFAS materials are known as “forever” chemicals that can remain in a subject's body as well as in the environment persistently, and (2) certain PFAS materials are known for damaging organs and causing fertility issues or cancers. However, using the same manufacturing processes as associated with the PFAS materials and the use of silicone monomers other than PFAS materials cannot achieve a comparable Dk. Thus, these rigid gas permeable contact lenses result in depletion of oxygen from the cornea and as well as potential long-term problems to the eye.

The illustrative embodiments disclosed herein overcome these and other drawbacks by providing improved rigid gas permeable contact lenses that are free of PFAS materials and have an oxygen permeability comparable, and in some cases better, than the rigid gas permeable contact lenses based on PFAS materials. In addition, the illustrative embodiments described herein further provide improved rigid gas permeable contact lenses that have a relatively high hardness thus allowing them to be machinable.

The term “monomer” as used herein refers to varying molecular weight compounds (i.e., monomers having number average molecular weights from about 300 to about 100,000 that can be polymerized, and medium to high molecular weight compounds or polymers, sometimes referred to as macromonomers containing functional groups capable of further polymerization. Thus, it is understood that the terms “organosilicon-containing monomers”, “silicone-containing monomers” and “hydrophilic monomers” include monomers, macromonomers and prepolymers. Prepolymers are partially polymerized monomers or monomers which are capable of further polymerization.

The rigid gas permeable contact lenses of the illustrative embodiments disclosed herein are based at least in part on a rigid gas permeable prepolymer comprising a reaction product of (a) a rigid gas permeable-forming prepolymer comprising (i) monomeric units derived from a bulky siloxane monomer containing an ethylenically unsaturated reactive end group; and (ii) monomeric units derived from a hydrophilic monomer having one or more reactive functionalities and an ethylenically unsaturated reactive end group; and (b) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer. By utilizing the pre-formed rigid gas permeable prepolymer in the monomeric mixture, the polymerized monomeric mixture will have a phase separation of silicone domains which percolate together to make micro channels to allow for oxygen permeability through the resulting rigid gas permeable contact lens. In addition, the rigid gas permeable contact lens-forming comonomer will provide the necessary hardness for the resulting rigid gas permeable contact lens.

Representative examples of the ethylenically unsaturated reactive end groups for use herein include, by way of example, (meth)acrylate-containing radicals, (meth)acrylamido-containing radicals, vinylcarbonate-containing radicals, vinylcarbamate-containing radicals, styrene-containing radicals, itaconate-containing radicals, vinyl-containing radicals, vinyloxy-containing radicals, fumarate-containing radicals, maleimide-containing radicals, vinylsulfonyl radicals and the like. As used herein, the term “(meth)” denotes an optional methyl substituent. Thus, for example, terms such as “(meth)acrylate” denotes either methacrylate or acrylate, and “(meth)acrylamide” denotes either methacrylamide or acrylamide.

In one illustrative embodiment, an ethylenically unsaturated reactive end group is represented by the general formula:

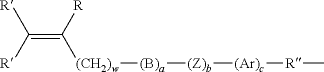

wherein R is hydrogen or a alkyl group having 1 to 6 carbon atoms such as methyl; each R′ is independently hydrogen, an alkyl radical having 1 to 6 carbon atoms, or a —CO—Y—R′″ radical wherein Y is —O—, —S— or —NH— and R′″ is an alkyl radical having 1 to about 10 carbon atoms; R″ is a linking group (e.g., a divalent alkenyl radical having 1 to about 12 carbon atoms); B denotes —O— or —NH—; Z denotes —CO—, —OCO— or —COO—; Ar denotes an aromatic radical having 6 to about 30 carbon atoms; w is 0 to 6; a is 0 or 1; b is 0 or 1; and c is 0 or 1.

In an illustrative embodiment, the rigid gas permeable-forming prepolymer first includes monomeric units derived from a bulky siloxane monomer containing an ethylenically unsaturated reactive end group. The term “bulky” refers to groups of a bulky siloxane monomer such as those represented by the structure of Formula I or Formula II that are sterically and/or electronically encumbering, i.e., sterically hindering. In a non-limiting illustrative embodiment, suitable bulky silicone-containing monomers include, for example, a bulky polysiloxanylalkyl (meth)acrylic monomer, a bulky polysiloxanylalkyl carbamate monomer and mixtures thereof. A representative example of a bulky silicone-containing monomer includes a bulky polysiloxanylalkyl (meth)acrylic monomer represented by a structure of Formula I:

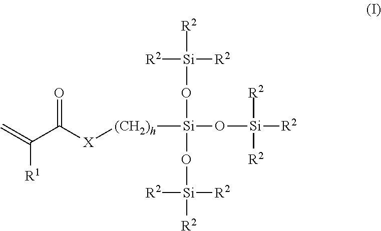

wherein X denotes —O— or —NR³—, where each R³ is hydrogen or a C₁-C₄ alkyl group; R¹ independently denotes hydrogen or methyl; each R² independently denotes an alkyl radical such as a C₁-C₆ group, a phenyl radical or a group represented by the following structure:

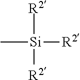

wherein each R^{2′} independently denotes an alkyl radical such as a C₁-C₆ group or a phenyl radical; and h is 1 to 10; or a bulky silicone-containing monomer represented by a structure of Formula II:

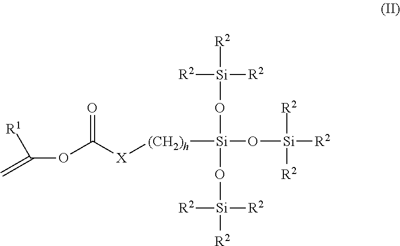

wherein X denotes —NR³— wherein R³ denotes hydrogen or a C₁-C₄ alkyl; R¹ denotes hydrogen or methyl; each R² independently denotes an alkyl radical such as a C₁-C₆ group, a phenyl radical or a group represented by the following structure:

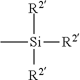

wherein each R^{2′} independently denotes an alkyl radical such as a C₁-C₆ group or a phenyl radical; and h is 1 to 10.

Representative examples of bulky silicone-containing monomers include 3-methacryloyloxypropyltris(trimethylsiloxy)silane or tris(trimethylsiloxy)silylpropyl methacrylate, sometimes referred to as TRIS, tris(trimethylsiloxy)silylpropyl vinyl carbamate, sometimes referred to as TRIS-VC, pentamethyldisiloxanyl methylmethacrylate, phenyltetramethyl-disiloxanylethyl acetate, and methyldi(trimethylsiloxy)methacryloxymethyl silane, (3-methacryloxy-2-hydroxy propoxy)propyl bis(trimethyl siloxy)methyl silane, sometimes referred to as Sigma and the like and mixtures thereof. In one embodiment, the bulky silicone-containing monomer is a tris(trialkylsiloxy)silylalkyl methacrylate-containing monomer such as a tris(trimethylsiloxy)silylpropyl methacrylate-containing monomer.

In non-limiting illustrative embodiments, as may be combined with one or more of the preceding paragraphs, the rigid gas permeable-forming prepolymer further includes monomeric units derived from a hydrophilic monomer having one or more reactive functionalities and an ethylenically unsaturated reactive end group. In an illustrative embodiment, suitable hydrophilic monomers include, for example, those containing an active hydrogen atom such as, for example, hydrophilic monomers having hydroxyl, amino or carboxylic acid reactive functionalities and an ethylenically unsaturated reactive end group as discussed above. Suitable hydroxy-substituted hydrophilic monomers include, for example, hydroxy (meth)acrylates and (meth)acrylamides, such as 2-hydroxyethyl methacrylate (HEMA), 2-hydroxyethyl acrylate (HEA), 4-hydroxybutyl acrylate, 4-hydroxybutyl methacrylate, glycerol methacrylate, glycerol acrylate, polyethylene glycol methacrylate, polyethylene glycol acrylate, N-2-hydroxyethyl methacrylamide and the like and mixtures thereof. Amino-substituted monomers include allyl amine.

In an illustrative embodiment, the rigid gas permeable-forming prepolymers disclosed herein can be prepared using techniques of controlled radical polymerization, e.g., by reversible addition-fragmentation chain transfer (RAFT) polymerization or atom-transfer radical polymerization (ATRP) employing a chain transfer agent that allows construction of the rigid gas permeable-forming prepolymers with a well-defined molecular weight distribution and narrow polydispersity. RAFT polymerization is particularly preferred because it is compatible with a wide variety of vinyl monomers.

In one illustrative embodiment, the rigid gas permeable-forming prepolymers can be obtained by first (1) mixing the bulky siloxane monomer containing an ethylenically unsaturated reactive end group and the hydrophilic monomer having one or more reactive functionalities and an ethylenically unsaturated reactive end group with a suitable chain transfer agent; (2) adding a polymerization initiator; (3) and subjecting the monomer/initiator mixture to a source of heat. The chain transfer agent serves to control the molecular weight of the resultant copolymer and provides hydroxy- or amino-functionality to the resultant polymer. Suitable chain transfer agents include mercapto alcohols (also referred to as hydroxymercaptans) and aminomercaptans such as, for example, hydroxyethylmercaptan, mercaptoethanol, and the like. Typical initiators include free-radical-generating polymerization initiators of the type illustrated by acetyl peroxide, lauroyl peroxide, decanoyl peroxide, coprylyl peroxide, benzoyl peroxide, tertiary butyl peroxypivalate, sodium percarbonate, tertiary butyl peroctoate, and azobis-isobutyronitrile (AIBN).

The reaction can be carried out at a temperature of between about 15° C. to about 120° C. for a time period of about 30 minutes to about 72 hours. The reaction can be carried out in the presence of a suitable solvent. Suitable solvents are in principle all solvents which dissolve the monomer used, for example, carboxamides such as dimethylformamide; dipolar aprotic solvents such as dimethyl sulfoxide; ketones such as acetone or cyclohexanone; hydrocarbons such as toluene, acetates such as anhydrous ethyl acetate and the like.

In an illustrative embodiment, the bulky siloxane monomer containing an ethylenically unsaturated reactive end group is employed in an amount ranging from about 20 to about 95 wt. %, based on the total weight of the mixture. In an illustrative embodiment, the hydrophilic monomer having one or more reactive functionalities and an ethylenically unsaturated reactive end group is employed in an amount ranging from about 3 to about 20 wt. %, based on the total weight of the mixture. In an illustrative embodiment, the chain transfer agent is employed in an amount ranging from about 0.1 to about 5 wt. %, based on the total weight of the mixture. The level of initiator employed will vary within the range of about 0.01 to about 2 wt. % of the mixture of monomers. If desired, the mixture of the above-mentioned monomers is warmed with addition of a free-radical former such as, for example, Luperox 26, Luperox 265, AIBN, Irgacure 819, and PTO.

A non-limiting schematic representation of a synthetic method for making the rigid gas permeable-forming prepolymer with a RAFT agent is set forth below in Scheme I.

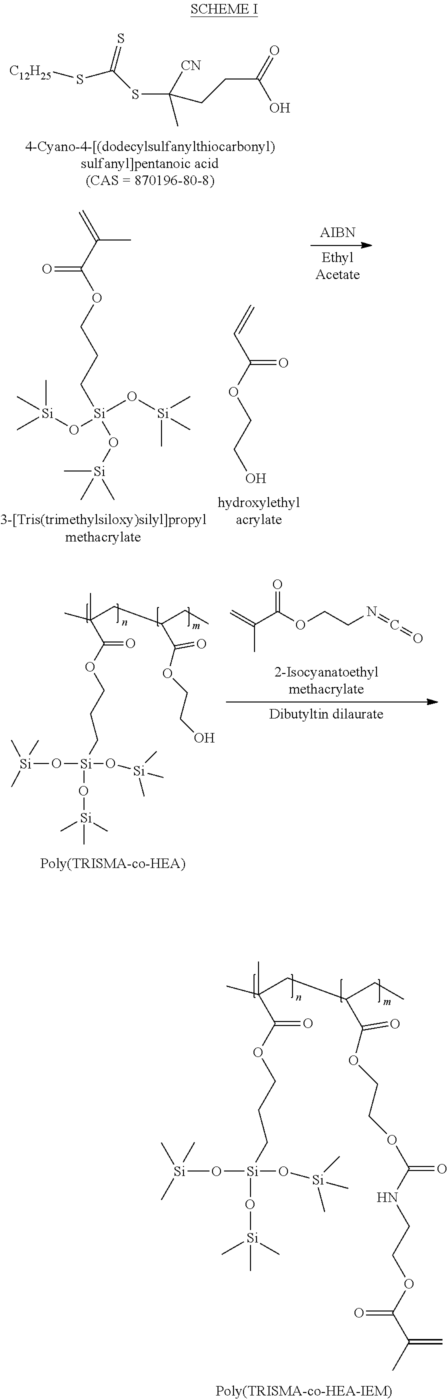

In the case where the rigid gas permeable-forming prepolymer disclosed herein is obtained from ATRP polymerization, the ethylenically unsaturated groups may be introduced by appropriate selection of a suitable ATRP initiator or by displacement reactions of the terminal halogen atom. Suitable ATRP groups for use herein include any standard monofunctional or difunctional ATRP group as is well known to those of ordinary skill in the art. A comprehensive review on the use of ATRP initiators or displacement of the terminal halogen using electrophilic, nucleophilic, and radical reactions to produce telechelic polymers is disclosed in, for example, Matyjaszewski, K.; Xia, J. Chem. Rev., 101, 2921-2990 (2001).

In one embodiment, a useful ATRP group includes an ethylenically unsaturated ATRP initiator such as, for example, vinyl functionalized ATRP initiators, e.g., prop-2-enyl-2′-bromoisobutyrate, vinyl chloroacetate, allyl chloroacetate, allyl bromide and the like. These initiators are used to polymerize either hydrophilic monomers or hydrophobic monomers.

In another embodiment, a useful ATRP group includes a non-ethylenically unsaturated ATRP initiator that can be converted to an ethylenically unsaturated initiator by a subsequent step. Examples of such initiators include α-bromo-isobutyric acid, hydroxyethyl 2-bromopropionate, glycidol 2-bromopropionate, tert-butyl 2-bromopropionate, and 4-bromobenzyl bromide, and the like.

In an illustrative embodiment, the rigid gas permeable-forming prepolymer is obtained from ATRP polymerization in a first step (a) by mixing either the bulky siloxane monomer containing an ethylenically unsaturated reactive end group or the hydrophilic monomer having one or more reactive functionalities and an ethylenically unsaturated reactive end group with, for example, an ATRP initiator and suitable ATRP catalyst such as a copper(I) bromide and subjecting the monomer/ATRP agent/initiator mixture to a source of heat. The reaction can be carried out at a temperature of between about 15° C. to about 120° C. for a time period of about 30 minutes to about 48 hours. If desired, the reaction can be carried out in the presence of a suitable solvent. Suitable solvents are in principle all solvents which dissolve the monomers used, for example, 1,4-dioxane, hexanol, dimethylformamide; acetone, cyclohexanone, toluene, and the like and mixtures thereof.

In an illustrative embodiment, the bulky siloxane monomer containing an ethylenically unsaturated reactive end group or the hydrophilic monomer having one or more reactive functionalities and an ethylenically unsaturated reactive end group is employed in an amount ranging from about 20 wt. % to about 95 wt. %, based on the total weight of the mixture. In an illustrative embodiment, the ATRP initiator is employed in an amount ranging from about 0.1 wt. % to about 5 wt. %, based on the total weight of the mixture. The level of catalyst employed will vary within the range of about 0.1 wt. % to about 5 wt. % of the mixture of monomers.

Next, in step (b) the resulting product of step (a) is then mixed with the other one of the bulky siloxane monomer containing an ethylenically unsaturated reactive end group or the hydrophilic monomer having one or more reactive functionalities and an ethylenically unsaturated reactive end group and an initiator and subjected to a source of heat as described above until the desired rigid gas permeable-forming prepolymer is formed. In an illustrative embodiment, the other one of the bulky siloxane monomer containing an ethylenically unsaturated reactive end group or the hydrophilic monomer having one or more reactive functionalities and an ethylenically unsaturated reactive end group is employed in an amount ranging from about 5 wt. % to about 30 wt. %, based on the total weight of the mixture. In an illustrative embodiment, the resulting product of step (a) is employed in an amount ranging from about 5 wt. % to about 20 wt. %, based on the total weight of the mixture.

The reaction can be carried out at a temperature of between about 30° C. to about 60° C. for about 0.5 to about 24 hours. The reaction can be carried out in the presence of a suitable solvent as discussed above.

A non-limiting schematic representation of a synthetic method for making the rigid gas permeable-forming prepolymer with an ATRP agent is set forth below in Scheme II.

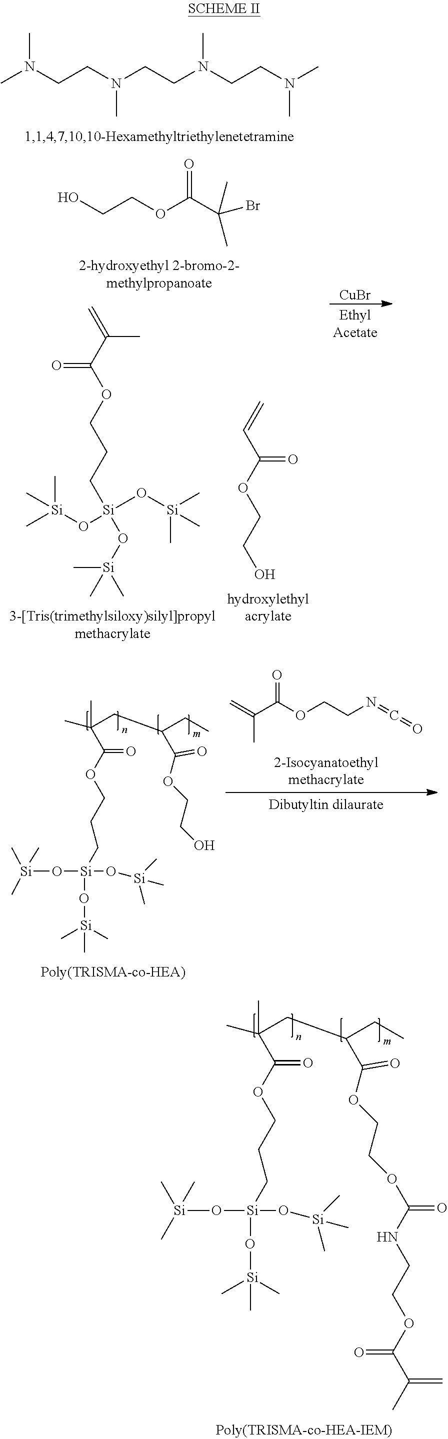

In one or more additional non-limiting illustrative embodiments, as may be combined with one or more of the preceding paragraphs, one or more additional monomeric units can be added to the rigid gas permeable-forming prepolymer using the methods disclosed above. In an illustrative embodiment, the one or more additional monomeric units can be derived from one or more monofunctional silicone comonomers having an ethylenically unsaturated polymerizable group. In an illustrative embodiment, a class of representative monofunctional silicone comonomers includes one or more non-bulky organosilicon-containing monomers. An “organosilicon-containing monomer” as used herein contains at least one [siloxanyl] or at least one [silyl-alkyl-siloxanyl] repeating unit, in a monomer, macromer or prepolymer. In an illustrative embodiment, an example of a non-bulky organosilicon-containing monomers is represented by a structure of Formula III:

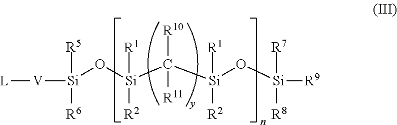

wherein L is an ethylenically unsaturated polymerizable group, V is a linking group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

Ethylenically unsaturated polymerizable groups are well known to those skilled in the art. Suitable ethylenically unsaturated polymerizable groups include, for example, (meth)acrylates, vinyl carbonates, O-vinyl carbamates, N-vinyl carbamates, and (meth)acrylamides.

Linking groups can be any divalent radical or moiety and include, for example, substituted or unsubstituted C₁ to C₁₂ alkyl group, an alkyl ether group, an alkenyl group, an alkenyl ether group, a halo alkyl group, a substituted or unsubstituted siloxane group, and monomers capable of propagating ring opening.

In one embodiment, V is a (meth)acrylate, L is a C₁ to C₁₂ alkylene group, R¹, R², R³, R⁴, R⁵, R⁶, R⁷, R⁸, and R⁹ are independently a C₁ to C₁₂ alkyl group, R¹⁰ and R¹¹ are independently H or a C₁ to C₁₂ alkyl group, y is 2 to 7 and n is 3 to 8.

In one embodiment, V is a (meth)acrylate, L is a C₁ to C₆ alkyl group, R¹, R², R³, R⁴, R⁵, R⁶, R⁷, R⁸, and R⁹ are independently a C₁ to C₆ alkyl group, R¹⁰ and R¹¹ are independently H or a C₁ to C₆ alkyl group, y is 2 to 7 and n is 1 to 20.

In an illustrative embodiment, as may be combined with one or more of the preceding paragraphs, the one or more non-bulky organosilicon-containing monomers can also comprise a compound represented by a structure of Formula IV:

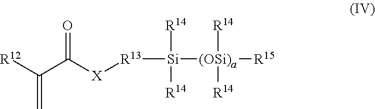

wherein R¹² is H or methyl; X is O or NR¹⁶; wherein R¹⁶ is selected from H, or C₁ to C₄ alkyl, which may be further substituted with one or more hydroxyl groups, and in some embodiments is H or methyl; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof, and in yet another embodiment a C₁ or C₃ to C₄ alkylene group which may be substituted with ether, hydroxyl and combinations thereof; each R¹⁴ is independently a phenyl or a C₁ to C₄ alkyl group which may be substituted with fluorine, hydroxyl or ether, and in another embodiment each R¹⁴ is independently selected from ethyl and methyl groups, and in yet another embodiment, each R¹⁴ is methyl; R¹⁵ is a C₁ to C₄ alkyl group; a is 2 to 50, and in some embodiments 5 to 15.

Non-bulky organosilicon-containing monomers represented by a structure of Formula IV are known in the art, see, e.g., U.S. Pat. Nos. 8,703,891, 8,937,110, 8,937,111, 9,156,934 and 9,244,197, the contents of which are incorporated by reference herein.

Representative examples of the non-bulky organosilicon-containing monomers include:

MIEDS6: a compound having the structure and available from Gelest:

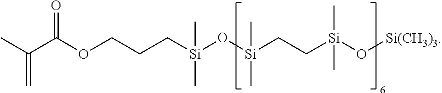

MCR-M11: a compound having the structure:

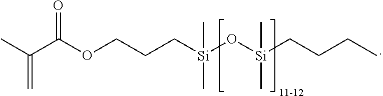

M1-MCR-C12: a compound having the structure:

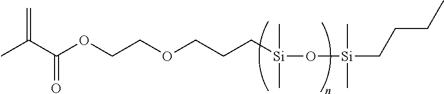

wherein n is an average of 12.

In an illustrative embodiment, as may be combined with one or more of the preceding paragraphs, a class of representative monofunctional silicone comonomers includes one or more polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacrylates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae V and VI:

E(*D*A*D*G)ₐ*D*A*D*E′; or (V)

E(*D*G*D*A)ₐ*D*A*D*E′; or (VI)
wherein:
   D independently denotes an alkyl diradical, an alkyl cycloalkyl diradical, a cycloalkyl diradical, an aryl diradical or an alkylaryl diradical having 6 to about 30 carbon atoms;
   G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;
   * denotes a urethane or ureido linkage;
   a is at least 1;
   A independently denotes a divalent polymeric radical of Formula VII:

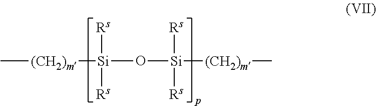

wherein each R^{s} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;
   each of E and E′ independently denotes a polymerizable unsaturated organic radical represented by Formula VIII:

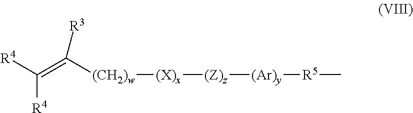

wherein: R³ is hydrogen or methyl;
R⁴ is hydrogen, an alkyl radical having 1 to 6 carbon atoms, or a —CO—Y—R⁶ radical wherein
Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

In an illustrative embodiment, as may be combined with one or more of the preceding paragraphs, a class of representative monofunctional silicone comonomers includes one or more silicone-containing urethane monomers represented by Formula IX:

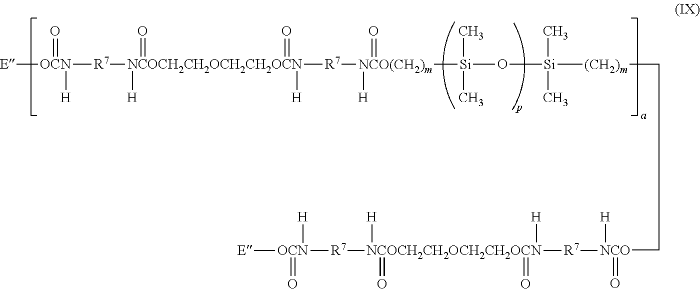

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

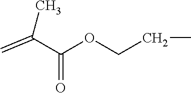

In an illustrative embodiment, as may be combined with one or more of the preceding paragraphs, a class of representative monofunctional silicone comonomers includes one or more monomers of Formula X:

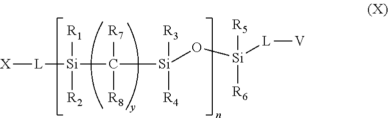

wherein X is the residue of a ring opening agent; L is the same or different and is a linking group or a bond; V is an ethylenically unsaturated polymerizable group; R₁, R₂, R₃, R₄, R₅, R₆ are independently hydrogen, an alkyl group, a haloalkyl group, a cycloalkyl group, a heterocycloalkyl group, an alkenyl group, a halo alkenyl group, or an aromatic group; R₇ and R₈ are independently hydrogen or an alkyl group wherein at least one of R₇ or R₈ is hydrogen; y is 2-7 and n is 1-100.

Ring opening agents are well known in the literature. Non-limiting examples of anionic ring opening agents include alkyl lithium, an alkoxide, trialkylsiloxylithium wherein the alkyl group may or may not contain halo atoms.

Linking groups can be any divalent radical or moiety and include substituted or unsubstituted alkyl, alkyl ether, alkenyls, alkenyl ethers, halo alkyls, substituted or unsubstituted siloxanes, and monomers capable of propagating ring opening.

Ethylenically unsaturated polymerizable groups are well known to those skilled in the art. Non-limiting examples of ethylenically unsaturated polymerizable groups would include acrylates, methacrylates, vinyl carbonates, O-vinyl carbamates, N-vinyl carbamates, acrylamides and methacrylamides.

In an illustrative embodiment, as may be combined with one or more of the preceding paragraphs, a class of representative monofunctional silicone comonomers includes one or more monomers of Formula XI:

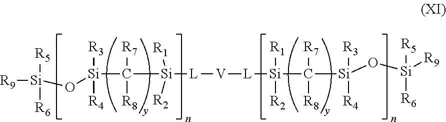

wherein L is the same or different and is a linking group or a bond; V is the same or different and is an ethylenically unsaturated polymerizable group; R₁, R₂, R₃, R₄, R₅, R₆ and R₉ are independently hydrogen, an alkyl group, a haloalkyl group, a cycloalkyl group, a heterocycloalkyl group, an alkenyl group, a halo alkenyl group, or an aromatic group; R₇ and R₈ are independently hydrogen or an alkyl group wherein at least one of R₇ or R₈ is hydrogen; y is 2-7 and n is 1-100.

In an illustrative embodiment, as may be combined with one or more of the preceding paragraphs, a class of representative monofunctional silicone comonomers includes one or more monomers of Formulae XII and XIII:

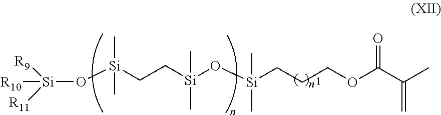

wherein R₉, R₁₀ and R₁₁ are independently hydrogen, an alkyl group, a haloalkyl group or other substituted alkyl groups; n is as defined above and n¹ is 0-10; and,

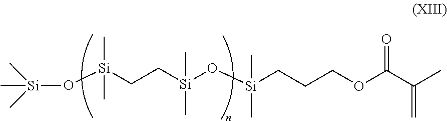

wherein n is 1 to 100, or n is 2 to 80, or n is 3 to 20, or n is 5 to 15.

In an illustrative embodiment, as may be combined with one or more of the preceding paragraphs, a class of representative monofunctional silicone comonomers includes one or more monomers of Formulas XIV-XVIII:

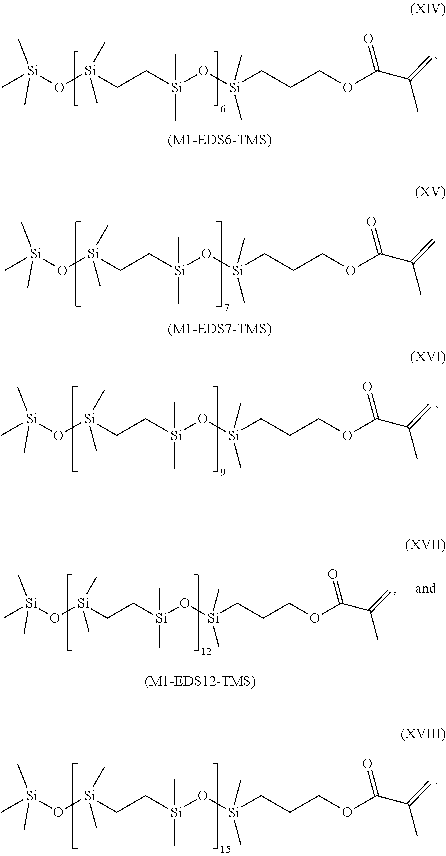

In an illustrative embodiment, as may be combined with one or more of the preceding paragraphs, a class of representative monofunctional silicone comonomers includes one or more monomers of Formulas XIX-XXI:

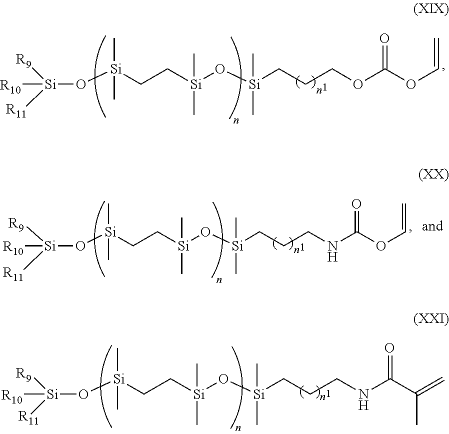

wherein R₉, R₁₀ and R₁₁ are independently hydrogen, an alkyl group, a haloalkyl group or other substituted alkyl groups and n and n¹ are as defined above.

In an illustrative embodiment, as may be combined with one or more of the preceding paragraphs, a class of representative monofunctional silicone comonomers includes one or more monomers of Formulas XXII-XXIV:

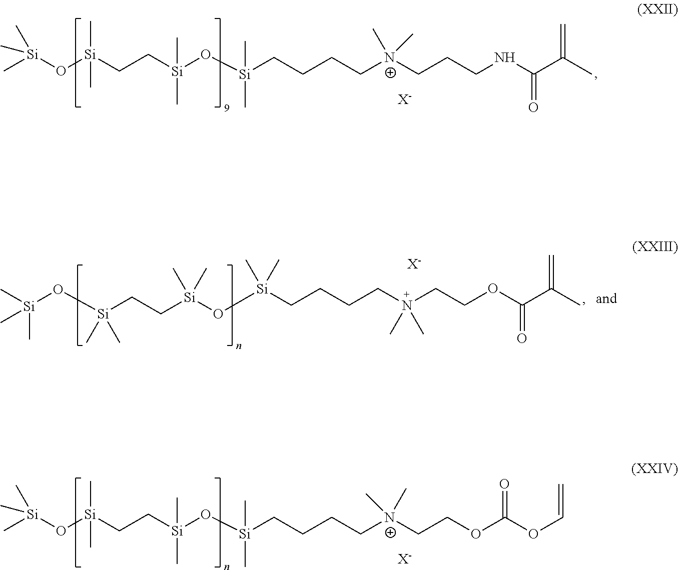

wherein n is as defined above and X⁻ is a counterion to provide an overall neutral charge.

Counterions capable of providing an overall neutral charge are well known to those of ordinary skill in the art and would include, for example, halide ions.

In an illustrative embodiment, as may be combined with one or more of the preceding paragraphs, a class of representative monofunctional silicone comonomers includes one or more monomers of Formula XXV:

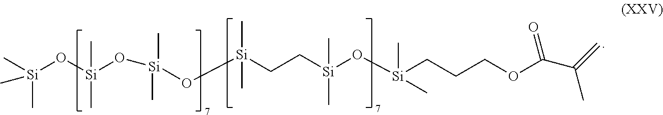

In accordance with one or more additional non-limiting illustrative embodiments, as may be combined with one or more of the preceding paragraphs, the one or more monofunctional silicone comonomers can be present in the reaction mixture in an amount ranging from about 5 wt. % to about 80 wt. %, based on the total weight of the monomeric mixture. In another illustrative embodiment, the one or more silicone hydrogel-forming silicone comonomers can be present in the monomeric mixture in an amount ranging from about 5 wt. % to about 80 wt. %, based on the total weight of the monomeric mixture.

The above silicone materials are merely exemplary, and other materials for use as substrates that have been disclosed in various publications and are being continuously developed for use in contact lenses and other silicone hydrogels can also be used.

In one or more additional non-limiting illustrative embodiments, as may be combined with one or more of the preceding paragraphs, the rigid gas permeable-forming prepolymer is thereafter reacted with a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer. As one skilled in the art will readily understand, the foregoing reaction will functionalize at least one of the one or more reactive functionalities present in the monomeric units derived from the hydrophilic monomer so that the monomeric units derived from the hydrophilic monomer will have an end functionalized group, i.e., a polymerizable ethylenically unsaturated reactive end group complementary to an ethylenically unsaturated reactive group of a rigid gas permeable contact lens-forming comonomer as discussed below. Suitable polymerizable ethylenically unsaturated reactive end groups can be any of those discussed above.

In an illustrative embodiment, a polymerizable ethylenically unsaturated reactive end group can be one or more of an acrylate and a methacrylate end group.

Suitable monomers having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer include, for example, 2-isocyanatocthyl acrylate, 3-isocyanatopropyl acrylate, 2-isocyanatoethyl methacrylate, 1-methyl-2-isocyanatoethyl methacrylate, 1,1-dimethyl-2-isocyanatoethyl acrylate, (meth)acryloyl chloride and the like.

In an illustrative embodiment, the rigid gas permeable-forming prepolymer is present in the reaction mixture in an amount ranging from about 5 wt. % to about 80 wt. %, based on the total weight of the reaction mixture. In an illustrative embodiment, the rigid gas permeable-forming prepolymer is present in the reaction mixture in an amount ranging from about 5 wt. % to about 65 wt. %, based on the total weight of the reaction mixture. In an illustrative embodiment, the monomer having a reactive functionality complementary to one of the one or more reactive functionalities of the hydrophilic monomer and a polymerizable ethylenically unsaturated reactive end group present in the reaction mixture in an amount ranging from about 1 wt. % to about 10 wt. %, based on the total weight of the mixture. In an illustrative embodiment, the monomer having a reactive functionality complementary to one of the one or more reactive functionalities of the hydrophilic monomer and a polymerizable ethylenically unsaturated reactive end group present in the reaction mixture in an amount ranging from about 1 wt. % to about 7 wt. %, based on the total weight of the mixture.

The reaction of the rigid gas permeable-forming prepolymer and the monomer having a reactive functionality complementary to one of the one or more reactive functionalities of the hydrophilic monomer and a polymerizable ethylenically unsaturated reactive end group can be carried out in the presence of a catalyst. Suitable catalysts include, for example, the stannous salts of carboxylic acids, such as stannous octoate, stannous oleate, stannous acetate, and stannous laurate, dialkyltin dicarboxylates, such as dibutyltin dilaurate and dibutyltin diacetate which are known in the art as urethane catalysts, as are tertiary amines and tin mercaptides. The amount of catalyst employed is generally between about 0.01 wt. % to about 5 wt. % of the mixture catalyzed.

The reaction can be carried out at a temperature of between about 0° C. to about 45° C. for about 1 to about 24 hours. The reaction can be carried out in the presence of a suitable solvent as discussed above.

As one skilled in the art will readily appreciate, the rigid gas permeable prepolymer of the reaction product will contain a balance of monomeric units derived from a bulky siloxane monomer containing an ethylenically unsaturated reactive end group, and monomeric units derived from a hydrophilic monomer having one or more reactive functionalities and an ethylenically unsaturated reactive end group. In non-limiting illustrative embodiments, the number of monomeric units derived from a bulky siloxane monomer containing an ethylenically unsaturated reactive end group can be from about 30 to about 500 units. In another non-limiting illustrative embodiment, the number of monomeric units derived from a bulky siloxane monomer containing an ethylenically unsaturated reactive end group can be from about 40 to about 300 units. In another non-limiting illustrative embodiment, the number of monomeric units derived from a bulky siloxane monomer containing an ethylenically unsaturated reactive end group can be from about 50 to about 100 units.

In non-limiting illustrative embodiments, the number of monomeric units derived from a hydrophilic monomer having one or more reactive functionalities and an ethylenically unsaturated reactive end group can be from about 10 to about 100 units. In another non-limiting illustrative embodiment, the number of monomeric units derived from a hydrophilic monomer having one or more reactive functionalities and an ethylenically unsaturated reactive end group can be from about 10 to about 50 units. In another non-limiting illustrative embodiment, the number of monomeric units derived from a hydrophilic monomer having one or more reactive functionalities and an ethylenically unsaturated reactive end group can be from about 10 to about 30 units.

In non-limiting illustrative embodiments, the number of one or more additional monomeric units such as those derived from be derived from one or more monofunctional silicone comonomers having an ethylenically unsaturated polymerizable group can be from about 20 to about 100 units. In another non-limiting illustrative embodiment, the number of one or more additional monomeric units such as those derived from be derived from one or more monofunctional silicone comonomers having an ethylenically unsaturated polymerizable group can be from about 5 to about 20 units.

Any combination of the forgoing ranges of numbers of monomeric units derived from a bulky siloxane monomer containing an ethylenically unsaturated reactive end group, the number of monomeric units derived from a hydrophilic monomer having one or more reactive functionalities and an ethylenically unsaturated reactive end group and the number of the one or more additional monomeric units are contemplated herein.

In one or more additional non-limiting illustrative embodiments, as may be combined with one or more of the preceding paragraphs, a rigid gas permeable contact lens is obtained from a polymerization product of one or more of the rigid gas permeable prepolymer disclosed herein and one or more rigid gas permeable contact lens-forming comonomers having an ethylenically unsaturated reactive group. As mentioned above, the rigid gas permeable-forming prepolymer is functionalized so that at least one of the one or more reactive functionalities present in the monomeric units derived from the hydrophilic monomer will have an end functionalized group, i.e., a polymerizable ethylenically unsaturated reactive end group complementary to an ethylenically unsaturated reactive group of a rigid gas permeable contact lens-forming comonomer. Accordingly, since the rigid gas permeable prepolymers are functionalized with polymerizable ethylenically unsaturated radicals, they are polymerizable by free radical polymerization with the one or more rigid gas permeable contact lens-forming comonomers.

In one or more additional non-limiting illustrative embodiments, as may be combined with one or more of the preceding paragraphs, suitable one or more rigid gas permeable contact lens-forming comonomers include, for example, one or more vinylaromatic compounds, i.e., compounds having only one vinyl group attached to an aromatic group and the di-, tri etc. vinylaromatic compounds having two or more vinyl groups attached to an aromatic group. Representative examples of vinylaromatic compounds include, but are not limited to, styrene, C₁ to C₆ alkyl-substituted styrene, and the like. Suitable C₁ to C₆ alkyl-substituted styrene compounds include, for example, 2-methyl styrene, 3-methyl styrene, 4-methyl styrene, 2,4-dimethyl, trimethyl styrene such as 2,4,6-trimethyl styrene, α-methyl styrene, 2,4-diisopropyl styrene and 4-tert-butyl styrene and the like. In an illustrative embodiment, suitable one or more rigid gas permeable contact lens-forming comonomers include a monovinylaromatic compound. In an illustrative embodiment, suitable one or more rigid gas permeable contact lens-forming comonomers include C₁ to C₆ alkyl-substituted styrene such as a tri C₁ to C₆ alkyl-substituted styrene.

In one or more additional non-limiting illustrative embodiments, as may be combined with one or more of the preceding paragraphs, suitable one or more rigid gas permeable contact lens-forming comonomers include, for example, ethylenically unsaturated hydrophobic monomers such as alkyl (meth)acrylates. Suitable alkyl (meth)acrylates include, for example, C₁-C₁₂ alkyl (meth)acrylates such as methyl methacrylate.

In accordance with one or more additional non-limiting illustrative embodiments, as may be combined with one or more of the preceding paragraphs, the one or more rigid gas permeable prepolymers can be present in the monomeric mixture in an amount ranging from about 20 wt. % to about 90 wt. % and the one or more rigid gas permeable contact lens-forming comonomers can be present in the monomeric mixture in an amount ranging from about 5 wt. % to about 80 wt. %, based on the total weight of the monomeric mixture. In another illustrative embodiment, the one or more rigid gas permeable prepolymers can be present in the monomeric mixture in an amount ranging from about 50 wt. % to about 80 wt. % and the one or more rigid gas permeable contact lens-forming comonomers can be present in the monomeric mixture in an amount ranging from about 10 wt. % to about 50 wt. %, based on the total weight of the monomeric mixture.

In one or more additional non-limiting illustrative embodiments, as may be combined with one or more of the preceding paragraphs, the monomeric mixtures can further include one or more additional rigid gas permeable contact lens-forming comonomers. Suitable one or more additional rigid gas permeable contact lens-forming comonomers include, for example, unsaturated carboxylic acids such as acrylic acid, methacrylic acid and the like. In an illustrative embodiment, the one or more additional rigid gas permeable contact lens-forming comonomers can be present in the monomeric mixture in an amount ranging from about 1 wt. % to about 15 wt. %, based on the total weight of the monomeric mixture.

In one or more additional non-limiting illustrative embodiments, as may be combined with one or more of the preceding paragraphs, the monomeric mixtures can further include one or more polysiloxane prepolymers represented by a structure of Formula XXVI:

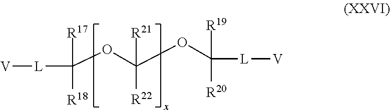

wherein each V is an independently reactive functional end group and includes, by way of example, an acrylate or methacrylate-containing reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 3 to 60.

Linking group L is independently a straight or branched alkyl group, cycloalkyl group, an aryl group, an ether or polyether group, and an ester group with as defined herein.

A representative example of a polysiloxane prepolymer is as follows:

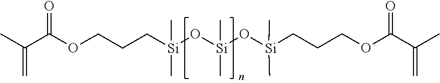

wherein n is from 5 to 100.

Another representative example of a polysiloxane prepolymer is as follows:

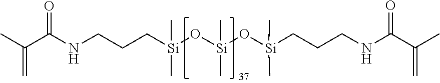

Methods for making the polysiloxane prepolymers described herein are well known and within the purview of one skilled in the art. In addition, the polysiloxane prepolymers are also commercially available from such sources as, for example, Gelest, Silar, Shin-Etsu, Momentive and Siltech.

In accordance with one or more additional non-limiting illustrative embodiments, as may be combined with one or more of the preceding paragraphs, the one or more polysiloxane prepolymers can be present in the monomeric mixture in an oxygen-permeable-enhancing amount, e.g., an amount ranging from about 2 wt. % to about 15 wt. %, based on the total weight of the monomeric mixture.

In accordance with one or more additional non-limiting illustrative embodiments, as may be combined with one or more of the preceding paragraphs, the monomeric mixtures disclosed herein may include one or more additional components. For example, when producing the rigid gas-permeable contact lenses according to the illustrative embodiments, the monomeric mixture may further include one or more crosslinking agents, a wetting monomer; and optionally other agents such as strengthening agents or UV absorbing or dye monomers. The crosslinking and wetting agents can include those crosslinking and wetting agents known in the prior art for making rigid gas permeable materials. The content of the crosslinking agent is chosen to provide a dimensionally stable lens material resistant to breakage and stress crazing. The amount of wetting monomer used is adjusted within limits to provide sufficient wetting characteristics so as to maintain a stable tear film while at the same time keeping a sufficiently low water content, e.g., a polymer system containing less than about 5 wt. % water.

In accordance with one or more additional non-limiting illustrative embodiments, as may be combined with one or more of the preceding paragraphs, the monomeric mixtures containing the one or more rigid gas permeable prepolymers and the one or more rigid gas permeable contact lens-forming comonomers disclosed herein may be polymerized by free radical polymerization by exposing the mixture to heat and/or radiation, e.g., ultraviolet light (UV), visible light, or high energy radiation, to produce a rigid gas permeable contact lenses according to conventional methods. A polymerization initiator may be included in the monomeric mixture to facilitate the polymerization step. Suitable free radical thermal polymerization initiators include, for example, organic peroxides such as, for example, acetal peroxide, lauroyl peroxide, decanoyl peroxide, stearoyl peroxide, benzoyl peroxide, tertiarylbutyl peroxypivalate, peroxydicarbonate, and the like and mixtures thereof. Suitable UV initiators include, for example, benzoin methyl ether, benzoin ethyl ether, Darocure 1173, 1164, 2273, 1116, 2959, 3331 (EM Industries) and Igracure 651 and 184 (Ciba-Geigy), and the like and mixtures thereof. Generally, the initiator will be employed in the monomeric mixture at a concentration at about 0.1 to about 5 wt. %, based on the total weight of the monomeric mixture.

In an illustrative embodiment, in producing the rigid gas permeable contact lenses of the illustrative embodiments, the monomeric mixture may be polymerized in tubes to provide rod-shaped articles, which are then cut into buttons. The buttons may then be lathed into rigid gas permeable contact lenses. Alternately, the rigid gas permeable contact lenses may be cast directly in molds from the monomeric mixtures, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the monomeric mixture to a mold, and spinning the mold in a controlled manner while exposing the monomeric mixture to a radiation source such as UV light. Static casting methods involve charging the monomeric mixture between two mold sections, one mold section shaped to form the anterior lens surface and the other mold section shaped to form the posterior lens surface, and curing the monomeric mixture while retained in the mold assembly to form a lens, for example, by free radical polymerization of the monomeric mixture. Examples of free radical reaction techniques to cure the lens material include thermal radiation, infrared radiation, electron beam radiation, gammma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a monomeric mixture is cured by spincasting in a mold to form a shaped article having an anterior lens surface and a relatively large thickness, and the posterior surface of the cured spincast article is subsequently lathed to provide a contact lens having the desired thickness and posterior lens surface.

When polymerizing the monomeric mixture by the thermal technique discussed above, a polymeric resin or metal material that is capable of withstanding high temperatures, i.e., thermally stable, should be employed as a contact lens mold. For example, in injection molding, the resin should have a heat deflection temperature of at least 350° C. and a hardness of at least 100 on the Rockwell Hardness Scale (M scale). Suitable resins include, but are not limited to, engineering plastics based on polyetherimide resins (e.g., ULTEM™ available from General Electric Co., Polymers Product Dept.); polyamide-imide plastics (e.g., TORLON available from Amoco Performance Products); polyphenylene sulfide plastics (e.g., RYTON™ available from Phillips Petroleum Co.); polysulfone and polyarylsulfone plastics (e.g., UDEL™ and RADEL™ available from Amoco Performance Products); polythalamide plastics (e.g., AMODEL available from Amoco Performance Products); polyketone plastics (e.g., KADEL™ available from Amoco Performance Products); various liquid crystal polymer resins (e.g., XYDAR™ available from Amoco Performance Products) and the like.

As one skilled in the art will readily understand, rigid gas permeable contact lenses are typically manufactured by lathing at least one surface from a blank of the resulting polymerization product, and in many cases, by lathing both the front and back surfaces as well as the diameter from a cylindrical button. Therefore, it is advantageous that the resulting polymerization product is not only optically clear, but also machinable. Accordingly, in an illustrative embodiment, the rigid gas permeable contact lenses disclosed herein can have a Shore D hardness of at least about 55. In an illustrative embodiment, the rigid gas permeable contact lenses disclosed herein can have a Shore D hardness of at least about 60. In an illustrative embodiment, the rigid gas permeable contact lenses disclosed herein can have a Shore D hardness of at least about 65. In an illustrative embodiment, the rigid gas permeable contact lenses disclosed herein can have a Shore D hardness of at least about 70. In another illustrative embodiment, the rigid gas permeable contact lenses disclosed herein can have a Shore D hardness of no more than about 80. Any combination of the forgoing ranges is contemplated herein.

In accordance with one or more additional non-limiting illustrative embodiments, as may be combined with one or more of the preceding paragraphs, the rigid gas permeable contact lenses disclosed herein can have an oxygen permeability (i.e., Dk) of at least about 100 barrers. In accordance with one or more additional non-limiting illustrative embodiments, as may be combined with one or more of the preceding paragraphs, the rigid gas permeable contact lenses disclosed herein can have an oxygen permeability of at least about 120 barrers. In accordance with one or more additional non-limiting illustrative embodiments, as may be combined with one or more of the preceding paragraphs, the rigid gas permeable contact lenses disclosed herein can have an oxygen permeability of at least about 140 barrers. In accordance with one or more additional non-limiting illustrative embodiments, as may be combined with one or more of the preceding paragraphs, the rigid gas permeable contact lenses disclosed herein can have an oxygen permeability of no more than 155 barrers. Any combination of the forgoing ranges of oxygen permeability is contemplated herein.

In accordance with one or more additional non-limiting illustrative embodiments, as may be combined with one or more of the preceding paragraphs, the rigid gas permeable contact lenses disclosed herein are free of any per- and polyfluoroalkyl substances (PFAS) materials.

The lens may then be transferred to individual lens packages containing a buffered saline solution. The saline solution may be added to the package either before or after transfer of the lens. Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, autoclaving.

As one skilled in the art will readily appreciate other steps may be included in the molding and packaging process described above. Such other steps can include, for example, coating the formed lens, surface treating the lens during formation (e.g., via mold transfer), inspecting the lens, discarding defective lenses, cleaning the mold halves, reusing the mold halves, and the like and combinations thereof.

The following examples are provided to enable one skilled in the art to practice the invention and are merely illustrative. The examples should not be read as limiting the scope of the invention as defined in the claims.

In the examples, the following abbreviation is used.

DMS-R18: A compound having the following structure and available from Gelest:

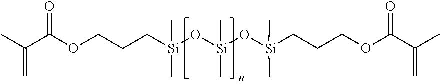

wherein n is 55.

TRIS: tris(trimethylsiloxy)silylpropyl methacrylate.

Various polymerization products were formed as discussed below and characterized by standard testing procedures such as:

Oxygen permeability (also referred to as Dk) is determined by the following procedure. Other methods and/or instruments may be used as long as the oxygen permeability values obtained therefrom are equivalent to the described method. The oxygen permeability of silicone hydrogels is measured by the polarographic method (ANSI Z80.20-1998) using an 02 Permeometer Model 201T instrument (Createch, Albany, Calif. USA) having a probe comprising a central, circular gold cathode at its end and a silver anode insulated from the cathode. Measurements are taken only on pre-inspected pinhole-free, flat silicone hydrogel film samples of three different center thicknesses ranging from 150 to 600 microns. Center thickness measurements of the film samples may be measured using a Rehder ET-1 electronic thickness gauge. Generally, the film samples have the shape of a circular disk. Measurements are taken with the film sample and probe immersed in a bath comprising circulating phosphate buffered saline (PBS) equilibrated at 35° C.+/−0.2°. Prior to immersing the probe and film sample in the PBS bath, the film sample is placed and centered on the cathode premoistened with the equilibrated PBS, ensuring no air bubbles or excess PBS exists between the cathode and the film sample, and the film sample is then secured to the probe with a mounting cap, with the cathode portion of the probe contacting only the film sample. For silicone hydrogel films, it is frequently useful to employ a Teflon polymer membrane, e.g., having a circular disk shape, between the probe cathode and the film sample. In such cases, the Teflon membrane is first placed on the pre-moistened cathode, and then the film sample is placed on the Teflon membrane, ensuring no air bubbles or excess PBS exists beneath the Teflon membrane or film sample. Once measurements are collected, only data with a correlation coefficient value (R2) of 0.97 or higher should be entered into the calculation of Dk value. At least two Dk measurements per thickness, and meeting R2 value, are obtained.

Using known regression analyses, oxygen permeability (Dk) is calculated from the film samples having at least three different thicknesses. Any film samples hydrated with solutions other than PBS are first soaked in purified water and allowed to equilibrate for at least 24 hours, and then soaked in PBS and allowed to equilibrate for at least 12 hours. The instruments are regularly cleaned and regularly calibrated using RGP standards. Upper and lower limits are established by calculating a +/−8.8% of the Repository values established by William J. Benjamin, et al., The Oxygen Permeability of Reference Materials, Optom Vis Sci 7 (12s): 95 (1997), the disclosure of which is incorporated herein in its entirety.

Shore D hardness may be measured according to ASTM D2240, employing a Shore D durometer on disk samples. Preferably, for both hardness methods, the samples are preconditioned by storing the samples for at least 40 hours in a chamber with 50% controlled humidity, such as by the method of ASTM E104-85.

### Example 1

### Preparation of a Rigid Gas Permeable Prepolymer.

Into an air free flask was placed 3-[tris(trimethylsiloxy) silyl]propyl methacrylate (100 g, 80 mole %), 2-hydroxyl ethyl acrylate (6.86 g, 20 mole %), mercaptoethanol (0.462 g, 2 mole %) and AIBN (0.098 g, 0.202 mole %) and dissolved in anhydrous ethyl acetate (170 mL). The flask was purged with nitrogen for 1 hour, closed and then placed in a preheated oil bath at 60° C. for 8 hours. The temperature was increased to 65° C. and continued for about a total of 24 hours. The reaction mixture was then cooled to 25° C. and called as the polymer.

To this polymer was then added dibutyltin dilaurate (0.1 g) and 2-isocyantoethyl methacrylate (9.618 g) and the reaction mixture was stirred for 12 hours at 25° C. Acetonitrile (100 mL) was then added to this reaction mixture and allowed to settle down for 2 hours for phase separation. The upper layer was decanted (265 mL solvent decanted) to leave a gummy mass. Ethyl acetate (20 mL) and acetonitrile (100 mL) was then added to this gummy mass and allowed to settle down for 2 hours. The upper layer was decanted (110 mL solvent decanted to yield a wet prepolymer. Next, the wet prepolymer was dried.

This reaction is generally shown below.

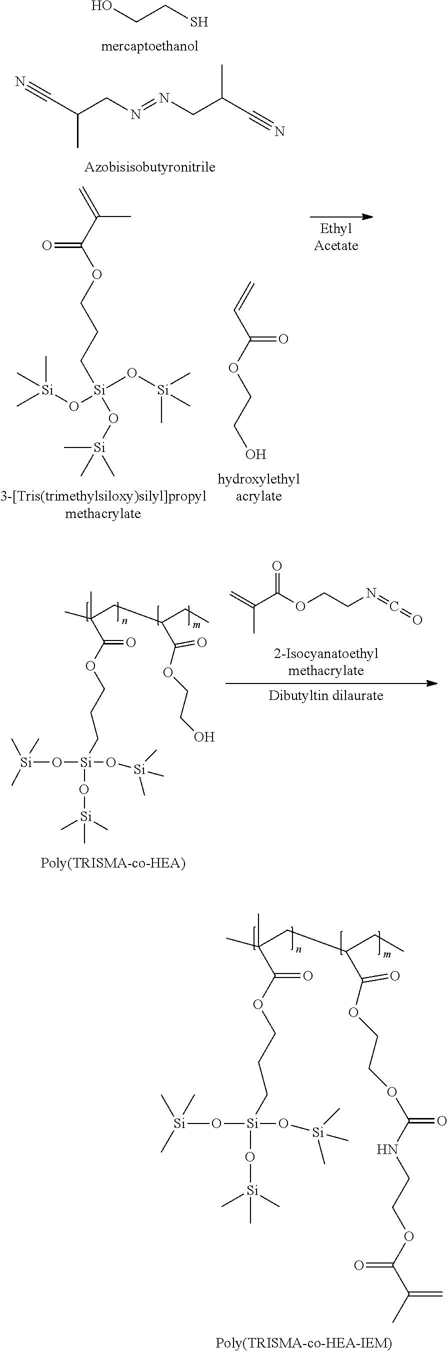

where m is 10 and n is 40.

### Examples 2 and 3

A monomeric mix was made by mixing the following components, listed in Table 1 at amounts per weight.

TABLE 1

| Formulation | Ex. 2 | Ex. 3 |
|---|---|---|
| Prepolymer of | 80 | 76.2 |
| Example 1 | | |
| Trimethyl Styrene | 10 | 9.52 |
| Methacrylic acid | 10 | 9.52 |
| DMS-R18 | — | 4.76 |
| Irgacure 819 | 0.25 | 0.50 |
| Total Part | 100.25 | 100.50 |
| Properties | | |
| Hardness | 72-73 | 74 |
| (Shore D) | | |
| Dk | 100 | 134 |

The monomeric mixture was prepared by mixing monomers and prepolymers with a speed mixer until the solution was homogeneous. The solution was filtrated through a PVDF membrane (0.45 um) with a prefilter of glass fiber (10 to 1 um). The filtrate was then cast into a polypropylene tube. The solution in the tube was degassed and refilled with nitrogen three times. The degassed tube was then transferred to a thermal oven for thermal curing process.

The cured RGP rod was removed from the polypropylene tube after the curing process. The rod was transferred to an oven at 100° C. for at least 12 hours for thermal annealing. The annealed RGP rod was then ready for lathe process. The rod was cut into several buttons. The buttons were lathed and polished into RGP lenses.

### Example 4 and Comparative Example A

A monomeric mix was made by mixing the following components, listed in Table 2 at amounts per weight.

TABLE 2

| | | Comp. |
|---|---|---|
| Formulation | Ex. 4 | Ex. A |
| Prepolymer of | 80 | — |
| Example 1 | | |
| Tris | — | 69.1 |
| Neopentyl | — | 11.1 |
| Glycoldimethacrylate | | |
| Methyl Methacrylate | 20 | 15 |
| Methacrylic acid | — | 5 |
| Total Part | 100 | 100 |
| Properties | | |
| Silicon Monomer, | 69.1 | 69.1 |
| wt. % | | |
| Hardness (Shore D) | 76 | 75-76 |
| Dk | 103 | 85 |

The monomeric mixture was prepared by mixing the components with a speed mixer until the solution was homogeneous. The solution was filtrated through a PVDF membrane (0.45 um) with a prefilter of glass fiber (10 to 1 um). The filtrate was then cast into a polypropylene tube. The solution in the tube was degassed and refilled with nitrogen three times. The degassed tube was then transferred to a thermal oven for thermal curing process.

The cured RGP rod was removed from the polypropylene tube after the curing process. The rod was transferred to an oven at 100° C. for at least 12 hours for thermal annealing. The annealed RGP rod was then ready for lathe process. The rod was cut into several buttons. The buttons were lathed and polished into RGP lenses.

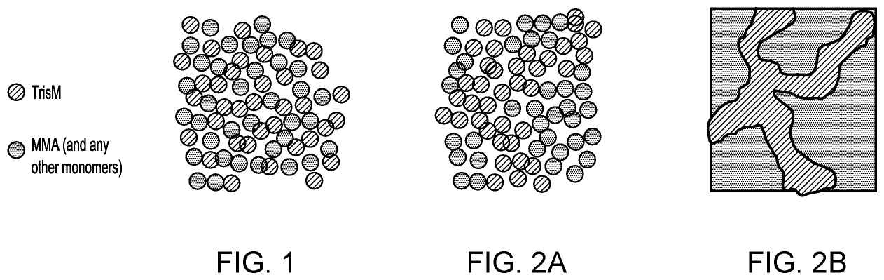

The RGP lens of Example 4 exhibited a significantly higher Dk than the RGP lens of Comparative Example A by utilizing the rigid gas permeable prepolymer in the monomeric mixture. When comparing FIG. 1 with FIG. 2A, it is seen that the significantly higher Dk of Example 4 utilizing the pre-formed rigid gas permeable prepolymer in the monomeric mixture was a result of the polymerized monomeric mixture having a phase separation of silicone domains that percolated together to make micro channels thereby allowing for oxygen permeability through the rigid gas permeable contact lens. The resulting microchannels are illustrated in FIG. 2B.

According to an aspect of the disclosure, a rigid gas permeable prepolymer comprises a reaction product of (a) a rigid gas permeable-forming prepolymer comprising (i) monomeric units derived from a bulky siloxane monomer containing an ethylenically unsaturated reactive end group, and (ii) monomeric units derived from a hydrophilic monomer having one or more reactive functionalities and an ethylenically unsaturated reactive end group, and (b) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer.

In non-limiting illustrative embodiments, as may be combined with one or more of the preceding paragraphs, the bulky siloxane monomer containing an ethylenically unsaturated reactive end group is one or more of a bulky polysiloxanylalkyl (meth)acrylic monomer, and a bulky polysiloxanylalkyl carbamate monomer.

In non-limiting illustrative embodiments, as may be combined with one or more of the preceding paragraphs, the bulky siloxane monomer containing an ethylenically unsaturated reactive end group is a bulky polysiloxanylalkyl (meth)acrylic monomer represented by a structure of Formula I:

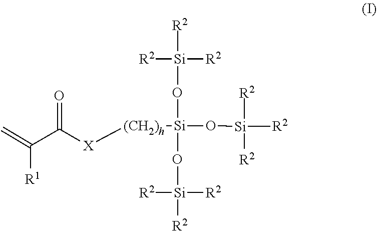

wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure:

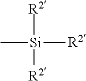

wherein each R^{2′} independently denotes an alkyl radical or a phenyl radical; and h is 1 to 10; or a bulky silicone-containing monomer represented by a structure of Formula II:

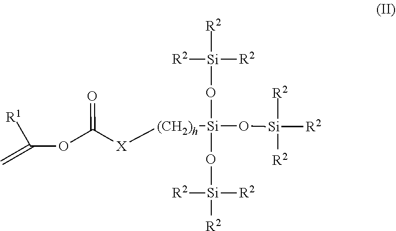

wherein X denotes —NR³— wherein R³ denotes hydrogen or a C₁-C₄ alkyl; R¹ denotes hydrogen or methyl; each R² independently denotes an alkyl radical, a phenyl radical or a group represented by the following structure:

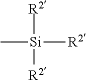

wherein each R^{2′} independently denotes an alkyl radical or a phenyl radical; and h is 1 to 10.

In non-limiting illustrative embodiments, as may be combined with one or more of the preceding paragraphs, the bulky siloxane monomer containing an ethylenically unsaturated reactive end group is tris(trimethylsiloxy)silylpropyl methacrylate, tris(trimethylsiloxy)silylpropyl vinyl carbamate, pentamethyldisiloxanyl methylmethacrylate, phenyltetramethyl-disiloxanylethyl acetate, and methyldi(trimethylsiloxy)methacryloxymethyl silane, and (3-methacryloxy-2-hydroxy propoxy)propyl bis(trimethyl siloxy)methyl silane.

In non-limiting illustrative embodiments, as may be combined with one or more of the preceding paragraphs, the bulky siloxane monomer containing an ethylenically unsaturated reactive end group is tris(trialkylsiloxy)silylalkyl methacrylate-containing monomer.

In non-limiting illustrative embodiments, as may be combined with one or more of the preceding paragraphs, wherein the hydrophilic monomer having one or more reactive functionalities and an ethylenically unsaturated reactive end group is a hydrophilic monomer having one or more of a hydroxyl, amino and a carboxylic acid reactive functionality.

In non-limiting illustrative embodiments, as may be combined with one or more of the preceding paragraphs, the hydrophilic monomer has an acrylate or methacrylate end group.

In non-limiting illustrative embodiments, as may be combined with one or more of the preceding paragraphs, the hydrophilic monomer having one or more reactive functionalities and an ethylenically unsaturated reactive end group is 2-hydroxyethyl methacrylate (HEMA), 2-hydroxyethyl acrylate (HEA), glycerol methacrylate, glycerol acrylate, polyethylene glycol methacrylate, polyethylene glycol acrylate, and N-2-hydroxyethyl methacrylamide.

In non-limiting illustrative embodiments, as may be combined with one or more of the preceding paragraphs, the monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer is one or more of 2-isocyanatocthyl acrylate, 3-isocyanatopropyl acrylate, 2-isocyanatocthyl methacrylate, 1-methyl-2-isocyanatocthyl methacrylate, 1,1-dimethy 1-2-isocyanatocthyl acrylate, and (meth)acryloyl chloride.

In non-limiting illustrative embodiments, as may be combined with one or more of the preceding paragraphs, a number of monomeric units derived from a bulky siloxane monomer containing an ethylenically unsaturated reactive end group can be from about 30 to about 500 units and a number of monomeric units derived from a hydrophilic monomer having one or more reactive functionalities and an ethylenically unsaturated reactive end group can be from about 10 to about 100 units.

In non-limiting illustrative embodiments, as may be combined with one or more of the preceding paragraphs, a number of monomeric units derived from a bulky siloxane monomer containing an ethylenically unsaturated reactive end group can be from about 40 to about 300 units and a number of monomeric units derived from a hydrophilic monomer having one or more reactive functionalities and an ethylenically unsaturated reactive end group can be from about 10 to about 50 units.

According to another aspect of the disclosure, a rigid gas permeable contact lens which is a polymerization product of a monomeric mixture comprises:
(a) a rigid gas permeable prepolymer comprising a reaction product of (i) a rigid gas permeable-forming prepolymer comprising (1) monomeric units derived from a bulky siloxane monomer containing an ethylenically unsaturated reactive end group, and (2) monomeric units derived from a hydrophilic monomer having one or more reactive functionalities and an ethylenically unsaturated reactive end group, and (ii) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer, and
(b) one or more rigid gas permeable contact lens-forming comonomers having an ethylenically unsaturated reactive group.

In non-limiting illustrative embodiments, as may be combined with one or more of the preceding paragraphs, the bulky siloxane monomer containing an ethylenically unsaturated reactive end group is one or more of a bulky polysiloxanylalkyl (meth)acrylic monomer, and a bulky polysiloxanylalkyl carbamate monomer.

In non-limiting illustrative embodiments, as may be combined with one or more of the preceding paragraphs, the bulky siloxane monomer containing an ethylenically unsaturated reactive end group is a bulky polysiloxanylalkyl (meth)acrylic monomer represented by a structure of Formula I:

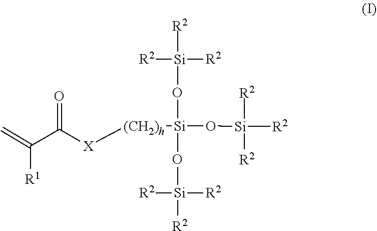

wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure:

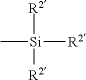

wherein each R^{2′} independently denotes an alkyl radical or a phenyl radical; and h is 1 to 10; or a bulky silicone-containing monomer represented by a structure of Formula II:

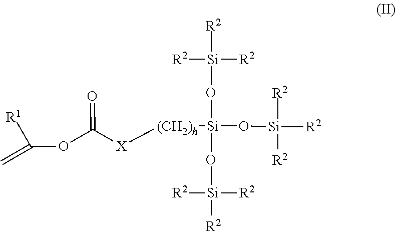

wherein X denotes —NR³— wherein R³ denotes hydrogen or a C₁-C₄ alkyl; R¹ denotes hydrogen or methyl; each R² independently denotes an alkyl radical, a phenyl radical or a group represented by the following structure:

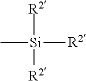

wherein each R^{2′} independently denotes an alkyl radical or a phenyl radical; and h is 1 to 10.

In non-limiting illustrative embodiments, as may be combined with one or more of the preceding paragraphs, the bulky siloxane monomer containing an ethylenically unsaturated reactive end group is tris(trimethylsiloxy)silylpropyl methacrylate, tris(trimethylsiloxy)silylpropyl vinyl carbamate, pentamethyldisiloxanyl methylmethacrylate, phenyltetramethyl-disiloxanylethyl acetate, and methyldi(trimethylsiloxy)methacryloxymethyl silane, and (3-methacryloxy-2-hydroxy propoxy)propyl bis(trimethyl siloxy)methyl silane.

In non-limiting illustrative embodiments, as may be combined with one or more of the preceding paragraphs, the bulky siloxane monomer containing an ethylenically unsaturated reactive end group is tris(trialkylsiloxy)silylalkyl methacrylate-containing monomer.

In non-limiting illustrative embodiments, as may be combined with one or more of the preceding paragraphs, the hydrophilic monomer having one or more reactive functionalities and an ethylenically unsaturated reactive end group is a hydrophilic monomer having one or more of a hydroxyl, amino and a carboxylic acid reactive functionality.

In non-limiting illustrative embodiments, as may be combined with one or more of the preceding paragraphs, the hydrophilic monomer has an acrylate or methacrylate end group.

In non-limiting illustrative embodiments, as may be combined with one or more of the preceding paragraphs, the hydrophilic monomer having one or more reactive functionalities and an ethylenically unsaturated reactive end group is 2-hydroxyethyl methacrylate (HEMA), 2-hydroxyethyl acrylate (HEA), glycerol methacrylate, glycerol acrylate, polyethylene glycol methacrylate, polyethylene glycol acrylate, and N-2-hydroxyethyl methacrylamide.

In non-limiting illustrative embodiments, as may be combined with one or more of the preceding paragraphs, the monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer is one or more of 2-isocyanatoethyl acrylate, 3-isocyanatopropyl acrylate, 2-isocyanatoethyl methacrylate, 1-methyl-2-isocyanatoethyl methacrylate, 1,1-dimethy 1-2-isocyanatocthyl acrylate, and (meth)acryloyl chloride

In non-limiting illustrative embodiments, as may be combined with one or more of the preceding paragraphs, a number of monomeric units derived from a bulky siloxane monomer containing an ethylenically unsaturated reactive end group can be from about 30 to about 500 units and a number of monomeric units derived from a hydrophilic monomer having one or more reactive functionalities and an ethylenically unsaturated reactive end group can be from about 10 to about 100 units.

In non-limiting illustrative embodiments, as may be combined with one or more of the preceding paragraphs, a number of monomeric units derived from a bulky siloxane monomer containing an ethylenically unsaturated reactive end group can be from 40 to about 300 units and a number of monomeric units derived from a hydrophilic monomer having one or more reactive functionalities and an ethylenically unsaturated reactive end group can be from about 10 to about 50 units.

In non-limiting illustrative embodiments, as may be combined with one or more of the preceding paragraphs, the one or more rigid gas permeable contact lens-forming comonomers comprise one or more vinylaromatic compounds, one or more alkyl (meth)acrylates or both.

In non-limiting illustrative embodiments, as may be combined with one or more of the preceding paragraphs, the one or more vinylaromatic compounds comprise one or more of styrene and a C₁ to C₆ alkyl-substituted styrene and the one or more alkyl (meth)acrylates comprise one or more C₁ to C₁₂ alkyl (meth)acrylates.

In non-limiting illustrative embodiments, as may be combined with one or more of the preceding paragraphs, the C₁ to C₆ alkyl-substituted styrene compound is one of 2-methyl styrene, 3-methyl styrene, 4-methyl styrene, 2,4-dimethyl, trimethyl styrene, α-methyl styrene, 2,4-diisopropyl styrene and 4-tert-butyl styrene.

In non-limiting illustrative embodiments, as may be combined with one or more of the preceding paragraphs, the alkyl (meth)acrylates include methyl acrylate, methyl methacrylate or both.

In non-limiting illustrative embodiments, as may be combined with one or more of the preceding paragraphs, the rigid gas permeable prepolymer is present in the monomeric mixture in an amount ranging from about 20 wt. % to about 90 wt. %, based on the total weight of the monomeric mixture, and the one or more rigid gas permeable contact lens-forming comonomers can be present in the monomeric mixture in an amount ranging from about 5 wt. % to about 80 wt. %, based on the total weight of the monomeric mixture.

In non-limiting illustrative embodiments, as may be combined with one or more of the preceding paragraphs, the one or more rigid gas permeable prepolymers are present in the monomeric mixture in an amount ranging from about 50 wt. % to about 80 wt. %, based on the total weight of the monomeric mixture, and the one or more rigid gas permeable contact lens-forming comonomers can be present in the monomeric mixture in an amount ranging from about 10 wt. % to about 50 wt. %, based on the total weight of the monomeric mixture.

In non-limiting illustrative embodiments, as may be combined with one or more of the preceding paragraphs, the monomeric mixture further comprises one or more additional rigid gas permeable contact lens-forming comonomers.

In non-limiting illustrative embodiments, as may be combined with one or more of the preceding paragraphs, the one or more additional rigid gas permeable contact lens-forming comonomers comprise an unsaturated carboxylic acid.

In non-limiting illustrative embodiments, as may be combined with one or more of the preceding paragraphs, the unsaturated carboxylic acid is acrylic acid or methacrylic acid.

In non-limiting illustrative embodiments, as may be combined with one or more of the preceding paragraphs, the one or more additional rigid gas permeable contact lens-forming comonomers are present in the monomeric mixture in an amount ranging from about 1 wt. % to about 15 wt. %, based on the total weight of the monomeric mixture.

In non-limiting illustrative embodiments, as may be combined with one or more of the preceding paragraphs, the monomeric mixture further comprises one or more polysiloxane prepolymers represented by a structure of Formula III:

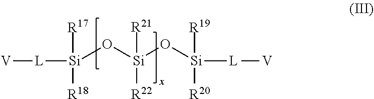

wherein each V is an independently reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 5 to 100.

In non-limiting illustrative embodiments, as may be combined with one or more of the preceding paragraphs, each V is independently an acrylate or a methacrylate-containing reactive functional end group.

In non-limiting illustrative embodiments, as may be combined with one or more of the preceding paragraphs, the one or more polysiloxane prepolymers comprise a polysiloxane prepolymer represented by the structure:

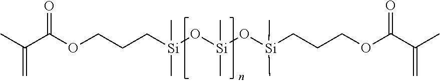

wherein n is from 5 to 100 or a polysiloxane prepolymer represented by the structure:

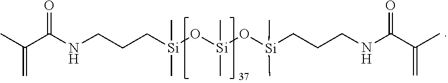

In non-limiting illustrative embodiments, as may be combined with one or more of the preceding paragraphs, the one or more polysiloxane prepolymers are present in the monomeric mixture in an amount ranging from about 2 wt. % to about 15 wt. %, based on the total weight of the monomeric mixture.

In non-limiting illustrative embodiments, as may be combined with one or more of the preceding paragraphs, the monomeric mixture further comprises one or more of a crosslinking agent, a wetting monomer, a strengthening agent and an ultraviolet absorber.

In non-limiting illustrative embodiments, as may be combined with one or more of the preceding paragraphs, the monomeric mixture is free of any per- and polyfluoroalkyl substances (PFAS) materials.

In non-limiting illustrative embodiments, as may be combined with one or more of the preceding paragraphs, the rigid gas permeable contact lens has an oxygen permeability of at least about 100 barrers and up to 155 barrers.

In non-limiting illustrative embodiments, as may be combined with one or more of the preceding paragraphs, the rigid gas permeable contact lens has a Shore D hardness of from about 55 to about 80.

According to yet another aspect of the disclosure, a method for making a rigid gas permeable contact lens, comprises:
(a) curing a monomeric mixture in a mold, the monomeric mixture comprising:
(i) a rigid gas permeable prepolymer comprising a reaction product of (ia) a rigid gas permeable-forming prepolymer comprising (1) monomeric units derived from a bulky siloxane monomer containing an ethylenically unsaturated reactive end group; and (2) monomeric units derived from a hydrophilic monomer having one or more reactive functionalities and an ethylenically unsaturated reactive end group; and (ib) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer; and
(ii) one or more rigid gas permeable contact lens-forming comonomers having an ethylenically unsaturated reactive group; and
(b) releasing the rigid gas permeable contact lens from the mold.

In non-limiting illustrative embodiments, as may be combined with one or more of the preceding paragraphs, the bulky siloxane monomer containing an ethylenically unsaturated reactive end group is one or more of a bulky polysiloxanylalkyl (meth)acrylic monomer, and a bulky polysiloxanylalkyl carbamate monomer.

In non-limiting illustrative embodiments, as may be combined with one or more of the preceding paragraphs, the bulky siloxane monomer containing an ethylenically unsaturated reactive end group is a bulky polysiloxanylalkyl (meth)acrylic monomer represented by a structure of Formula I:

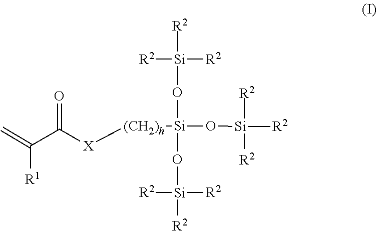

wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure:

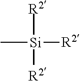

wherein each R^{2′} independently denotes an alkyl radical or a phenyl radical; and h is 1 to 10; or a bulky silicone-containing monomer represented by a structure of Formula II:

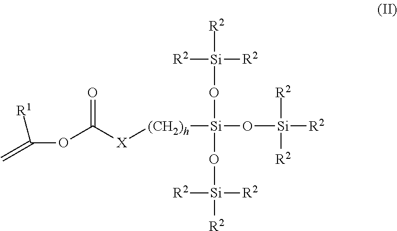

wherein X denotes —NR³— wherein R³ denotes hydrogen or a C₁-C₄ alkyl; R¹ denotes hydrogen or methyl; each R¹⁸ independently denotes an alkyl radical, a phenyl radical or a group represented by the following structure:

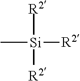

wherein each R^{2′} independently denotes an alkyl radical or a phenyl radical; and h is 1 to 10.

In non-limiting illustrative embodiments, as may be combined with one or more of the preceding paragraphs, the bulky siloxane monomer containing an ethylenically unsaturated reactive end group is tris(trimethylsiloxy)silylpropyl methacrylate, tris(trimethylsiloxy)silylpropyl vinyl carbamate, pentamethyldisiloxanyl methylmethacrylate, phenyltetramethyl-disiloxanylethyl acetate, and methyldi(trimethylsiloxy)methacryloxymethyl silane, and (3-methacryloxy-2-hydroxy propoxy)propyl bis(trimethyl siloxy)methyl silane.

In non-limiting illustrative embodiments, as may be combined with one or more of the preceding paragraphs, the bulky siloxane monomer containing an ethylenically unsaturated reactive end group is tris(trialkylsiloxy)silylalkyl methacrylate-containing monomer.

In non-limiting illustrative embodiments, as may be combined with one or more of the preceding paragraphs, the hydrophilic monomer having one or more reactive functionalities and an ethylenically unsaturated reactive end group is a hydrophilic monomer having one or more of a hydroxyl, amino and a carboxylic acid reactive functionality.

In non-limiting illustrative embodiments, as may be combined with one or more of the preceding paragraphs, the hydrophilic monomer has an acrylate or methacrylate end group.

In non-limiting illustrative embodiments, as may be combined with one or more of the preceding paragraphs, the hydrophilic monomer having one or more reactive functionalities and an ethylenically unsaturated reactive end group is 2-hydroxyethyl methacrylate (HEMA), 2-hydroxyethyl acrylate (HEA), glycerol methacrylate, glycerol acrylate, polyethylene glycol methacrylate, polyethylene glycol acrylate, and N-2-hydroxyethyl methacrylamide.

In non-limiting illustrative embodiments, as may be combined with one or more of the preceding paragraphs, the monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer is one or more of 2-isocyanatoethyl acrylate, 3-isocyanatopropyl acrylate, 2-isocyanatocthyl methacrylate, 1-methyl-2-isocyanatoethyl methacrylate, 1,1-dimethyl-2-isocyanatoethyl acrylate, and (meth)acryloyl chloride

In non-limiting illustrative embodiments, as may be combined with one or more of the preceding paragraphs, a number of monomeric units derived from a bulky siloxane monomer containing an ethylenically unsaturated reactive end group can be from about 30 to about 500 units and a number of monomeric units derived from a hydrophilic monomer having one or more reactive functionalities and an ethylenically unsaturated reactive end group can be from about 10 to about 100 units.

In non-limiting illustrative embodiments, as may be combined with one or more of the preceding paragraphs, a number of monomeric units derived from a bulky siloxane monomer containing an ethylenically unsaturated reactive end group can be from 40 to about 300 units and a number of monomeric units derived from a hydrophilic monomer having one or more reactive functionalities and an ethylenically unsaturated reactive end group can be from about 10 to about 50 units.

In non-limiting illustrative embodiments, as may be combined with one or more of the preceding paragraphs, the one or more rigid gas permeable contact lens-forming comonomers comprise one or more vinylaromatic compounds, one or more alkyl (meth)acrylates or both.

In non-limiting illustrative embodiments, as may be combined with one or more of the preceding paragraphs, the one or more vinylaromatic compounds comprise one or more of styrene and a C₁ to C₆ alkyl-substituted styrene and the one or more alkyl (meth)acrylates comprise one or more C₁ to C₁₂ alkyl (meth)acrylates.

In non-limiting illustrative embodiments, as may be combined with one or more of the preceding paragraphs, the C₁ to C₆ alkyl-substituted styrene compound is one of 2-methyl styrene, 3-methyl styrene, 4-methyl styrene, 2,4-dimethyl, trimethyl styrene, α-methyl styrene, 2,4-diisopropyl styrene and 4-tert-butyl styrene.

In non-limiting illustrative embodiments, as may be combined with one or more of the preceding paragraphs, the alkyl (meth)acrylates include methyl acrylate, methyl methacrylate or both.

In non-limiting illustrative embodiments, as may be combined with one or more of the preceding paragraphs, the rigid gas permeable prepolymer is present in the monomeric mixture in an amount ranging from about 20 wt. % to about 90 wt. %, based on the total weight of the monomeric mixture, and the one or more rigid gas permeable contact lens-forming comonomers can be present in the monomeric mixture in an amount ranging from about 5 wt. % to about 80 wt. %, based on the total weight of the monomeric mixture.

In non-limiting illustrative embodiments, as may be combined with one or more of the preceding paragraphs, the rigid gas permeable prepolymer is present in the monomeric mixture in an amount ranging from about 50 wt. % to about 80 wt. %, based on the total weight of the monomeric mixture, and the one or more rigid gas permeable contact lens-forming comonomers can be present in the monomeric mixture in an amount ranging from about 10 wt. % to about 50 wt. %, based on the total weight of the monomeric mixture.

In non-limiting illustrative embodiments, as may be combined with one or more of the preceding paragraphs, the monomeric mixture further comprises one or more additional rigid gas permeable contact lens-forming comonomers.

In non-limiting illustrative embodiments, as may be combined with one or more of the preceding paragraphs, the one or more additional rigid gas permeable contact lens-forming comonomers comprise an unsaturated carboxylic acid.

In non-limiting illustrative embodiments, as may be combined with one or more of the preceding paragraphs, the unsaturated carboxylic acid is acrylic acid or methacrylic acid.

In non-limiting illustrative embodiments, as may be combined with one or more of the preceding paragraphs, the one or more additional rigid gas permeable contact lens-forming comonomers are present in the monomeric mixture in an amount ranging from about 1 wt. % to about 15 wt. %, based on the total weight of the monomeric mixture.

In non-limiting illustrative embodiments, as may be combined with one or more of the preceding paragraphs, the monomeric mixture further comprises one or more polysiloxane prepolymers represented by a structure of Formula III:

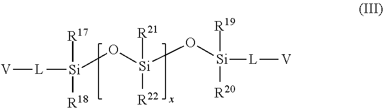

wherein each V is an independently reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 5 to 100.

In non-limiting illustrative embodiments, as may be combined with one or more of the preceding paragraphs, each V is independently an acrylate or a methacrylate-containing reactive functional end group.

In non-limiting illustrative embodiments, as may be combined with one or more of the preceding paragraphs, the one or more polysiloxane prepolymers comprise a polysiloxane prepolymer represented by the structure:

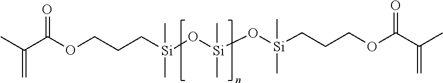

wherein n is from 5 to 100 or a polysiloxane prepolymer represented by the structure:

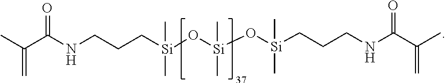

In non-limiting illustrative embodiments, as may be combined with one or more of the preceding paragraphs, the one or more polysiloxane prepolymers are present in the monomeric mixture in an amount ranging from about 2 wt. % to about 15 wt. %, based on the total weight of the monomeric mixture.

In non-limiting illustrative embodiments, as may be combined with one or more of the preceding paragraphs, the monomeric mixture further comprises one or more of a crosslinking agent, a wetting monomer, a strengthening agent and an ultraviolet absorber.

In non-limiting illustrative embodiments, as may be combined with one or more of the preceding paragraphs, the rigid gas permeable contact lens is free of any per- and polyfluoroalkyl substances (PFAS) materials.

In non-limiting illustrative embodiments, as may be combined with one or more of the preceding paragraphs, the rigid gas permeable contact lens has an oxygen permeability of at least about 100 barrers and up to 155 barrers.

In non-limiting illustrative embodiments, as may be combined with one or more of the preceding paragraphs, the rigid gas permeable contact lens has a Shore D hardness of from about 55 to about 80.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A rigid gas permeable prepolymer comprising a reaction product of (a) a rigid gas permeable-forming prepolymer comprising (i) monomeric units derived from a bulky siloxane monomer containing an ethylenically unsaturated reactive end group; and (ii) monomeric units derived from a hydrophilic monomer having one or more reactive functionalities and an ethylenically unsaturated reactive end group; and (b) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer.

2. The rigid gas permeable prepolymer according to claim 1, wherein the bulky siloxane monomer containing an ethylenically unsaturated reactive end group is one or more of a bulky polysiloxanylalkyl (meth)acrylic monomer, and a bulky polysiloxanylalkyl carbamate monomer.

3. The rigid gas permeable prepolymer according to claim 1, wherein the bulky siloxane monomer containing an ethylenically unsaturated reactive end group is a bulky polysiloxanylalkyl (meth)acrylic monomer represented by a structure of Formula I: 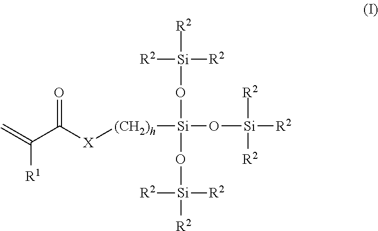
wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure: 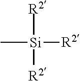
wherein each R^{2′} independently denotes an alkyl radical or a phenyl radical; and h is 1 to 10; or a bulky silicone-containing monomer represented by a structure of Formula II: 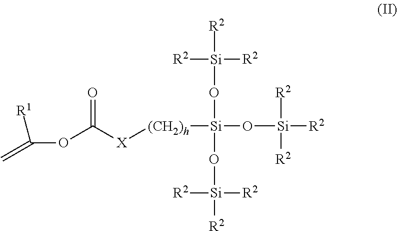
wherein X denotes —NR³— wherein R³ denotes hydrogen or a C₁-C₄ alkyl; R¹ denotes hydrogen or methyl; each R² independently denotes an alkyl radical, a phenyl radical or a group represented by the following structure: 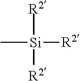
wherein each R^{2′} independently denotes an alkyl radical or a phenyl radical; and h is 1 to 10.

4. The rigid gas permeable prepolymer according to claim 1, wherein the hydrophilic monomer having one or more reactive functionalities and an ethylenically unsaturated reactive end group is a hydrophilic monomer having one or more of a hydroxyl, amino and a carboxylic acid reactive functionality and an acrylate or methacrylate end group.

5. The rigid gas permeable prepolymer according to claim 1, wherein the hydrophilic monomer having one or more reactive functionalities and an ethylenically unsaturated reactive end group is selected from the group consisting of 2-hydroxyethyl methacrylate (HEMA), 2-hydroxyethyl acrylate (HEA), glycerol methacrylate, glycerol acrylate, polyethylene glycol methacrylate, polyethylene glycol acrylate, and N-2-hydroxyethyl methacrylamide.

6. The rigid gas permeable prepolymer according to claim 1, wherein the monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer is one or more of 2-isocyanatoethyl acrylate, 3-isocyanatopropyl acrylate, 2-isocyanatoethyl methacrylate, 1-methyl-2-isocyanatoethyl methacrylate, 1,1-dimethy 1-2-isocyanatoethyl acrylate, and (meth)acryloyl chloride.

7. The rigid gas permeable prepolymer according to claim 1, wherein a number of monomeric units derived from a bulky siloxane monomer containing an ethylenically unsaturated reactive end group is from about 30 to about 500 units and a number of monomeric units derived from a hydrophilic monomer having one or more reactive functionalities and an ethylenically unsaturated reactive end group is from about 10 to about 100 units.

8. The rigid gas permeable prepolymer according to claim 1, further comprising one or more additional monomeric units derived from one or more monofunctional silicone comonomers having an ethylenically unsaturated polymerizable group.

9. A rigid gas permeable contact lens which is a polymerization product of a monomeric mixture comprising:
(a) a rigid gas permeable prepolymer comprising a reaction product of (i) a rigid gas permeable-forming prepolymer comprising (1) monomeric units derived from a bulky siloxane monomer containing an ethylenically unsaturated reactive end group; and (2) monomeric units derived from a hydrophilic monomer having one or more reactive functionalities and an ethylenically unsaturated reactive end group; and (ii) a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer; and
(b) one or more rigid gas permeable contact lens-forming comonomers having an ethylenically unsaturated reactive group.

10. The rigid gas permeable contact lens according to claim 9, wherein the bulky siloxane monomer containing an ethylenically unsaturated reactive end group is one or more of a bulky polysiloxanylalkyl (meth)acrylic monomer, and a bulky polysiloxanylalkyl carbamate monomer, and the hydrophilic monomer having one or more reactive functionalities and an ethylenically unsaturated reactive end group is a hydrophilic monomer having one or more of a hydroxyl, amino and a carboxylic acid reactive functionality and an acrylate or methacrylate end group.

11. The rigid gas permeable contact lens according to claim 9, wherein the bulky siloxane monomer containing an ethylenically unsaturated reactive end group is a bulky polysiloxanylalkyl (meth)acrylic monomer represented by a structure of Formula I: 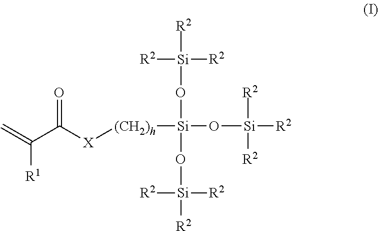
wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure: 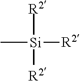
wherein each R^{2′} independently denotes an alkyl radical or a phenyl radical; and h is 1 to 10; or a bulky silicone-containing monomer represented by a structure of Formula II: 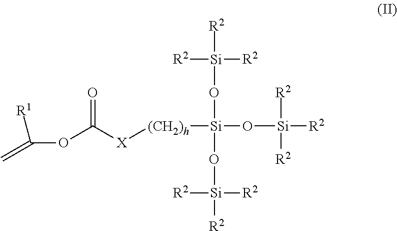
wherein X denotes —NR³— wherein R³ denotes hydrogen or a C₁-C₄ alkyl; R¹ denotes hydrogen or methyl; each R¹⁸ independently denotes an alkyl radical, a phenyl radical or a group represented by the following structure: 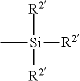
wherein each R^{2′} independently denotes an alkyl radical or a phenyl radical; and h is 1 to 10, and the hydrophilic monomer having one or more reactive functionalities and an ethylenically unsaturated reactive end group is selected from the group consisting of 2-hydroxyethyl methacrylate (HEMA), 2-hydroxyethyl acrylate (HEA), glycerol methacrylate, glycerol acrylate, polyethylene glycol methacrylate, polyethylene glycol acrylate, and N-2-hydroxyethyl methacrylamide.

12. The rigid gas permeable contact lens according to claim 10, wherein the monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer is one or more of 2-isocyanatoethyl acrylate, 3-isocyanatopropyl acrylate, 2-isocyanatoethyl methacrylate, 1-methyl-2-isocyanatoethyl methacrylate, 1,1-dimethy 1-2-isocyanatoethyl acrylate, and (meth)acryloyl chloride.

13. The rigid gas permeable contact lens according to claim 9, wherein a number of monomeric units derived from a bulky siloxane monomer containing an ethylenically unsaturated reactive end group is from about 30 to about 500 units and a number of monomeric units derived from a hydrophilic monomer having one or more reactive functionalities and an ethylenically unsaturated reactive end group is from about 10 to about 100 units.

14. The rigid gas permeable contact lens according to claim 9, wherein the one or more rigid gas permeable contact lens-forming comonomers comprise one or more vinylaromatic compounds, one or more alkyl (meth)acrylates or both.

15. The rigid gas permeable contact lens according to claim 14, wherein the one or more vinylaromatic compounds comprise one or more of styrene and a C₁ to C₆ alkyl-substituted styrene, and the one or more alkyl (meth)acrylates comprise one or more C₁ to C₁₂ alkyl (meth)acrylates.

16. The rigid gas permeable contact lens according to claim 9, wherein the rigid gas permeable prepolymer is present in the monomeric mixture in an amount ranging from about 20 wt. % to about 90 wt. %, based on the total weight of the monomeric mixture, and the one or more rigid gas permeable contact lens-forming comonomers are present in the monomeric mixture in an amount ranging from about 5 wt. % to about 80 wt. %, based on the total weight of the monomeric mixture.

17. The rigid gas permeable contact lens according to claim 9, wherein the monomeric mixture further comprises one or more of an unsaturated carboxylic acid, a polysiloxane prepolymer represented by a structure of Formula III: 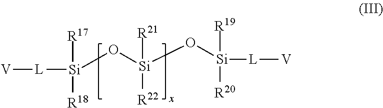
wherein each V is an independently reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 5 to 100, or both.

18. The rigid gas permeable contact lens according to claim 9, wherein the monomeric mixture is free of any per- and polyfluoroalkyl substances (PFAS) materials.

19. The rigid gas permeable contact lens according to claim 9, having one or more of an oxygen permeability of at least about 100 barrers and up to 155 barrers and a Shore D hardness of from about 55 to about 80.

20. A method for making a rigid gas permeable contact lens, comprising:
(a) curing a monomeric mixture in a mold, the monomeric mixture comprising:
(i) a rigid gas permeable prepolymer according to claim 1; and
(ii) one or more rigid gas permeable contact lens-forming comonomers having an ethylenically unsaturated reactive group; and
(b) releasing the rigid gas permeable contact lens from the mold.
